(19) United States
(12) Patent Application Publication
(10) Pub. No.: US 2026/0224034 A1
(43) Pub. Date: Aug. 6, 2026

(54) CUSHION BODY

(71) Applicant: TOYOTA BOSHOKU KABUSHIKI KAISHA, Aichi-ken (JP)

(72) Inventor: Hiroaki NATSUME, Aichi-ken (JP)

(73) Assignee: TOYOTA BOSHOKU KABUSHIKI KAISHA, Aichi-ken (JP)

(21) Appl. No.: 19/448,398

(22) Filed: Jan. 14, 2026

(30) Foreign Application Priority Data
Feb. 3, 2025 (JP) 2025-015932

(51) Int. Cl. A47C 7/24; A47C 7/74; B60N 2/64

(52) U.S. Cl. CPC A47C 7/24; A47C 7/74; B60N 2/64

(57) ABSTRACT

A cushion body that elastically supports a seater is divided into three elements: a central portion forming a central part in a seat width direction, and two side portions forming respective side parts in the seat width direction. At least one of the divided elements includes a seat pad, a base substrate provided on the back surface of the seat pad, and a seat cover that covers the seat pad from the front side, with its terminal portion fixed to the base substrate. The seat pad has a through-hole formed in its thickness direction. To suppress sound leakage, a soundproofing member is provided to fill a gap between the seat pad and the base substrate, configured to surround the through-hole.

### CROSS-REFERENCE TO RELATED APPLICATION

This application claims priority to Japanese patent application serial number 2025-15932 filed February 3, 2025, the contents of which are incorporated herein by reference in its entirety for all purposes.

### TECHNICAL FIELD

The present disclosure relates to a cushion body. In particular, the present disclosure relates to a cushion body that elastically supports a seater.

### BACKGROUND

Conventionally, there has been known a seat including a cushion body having a seat pad and a seat cover that covers the seat pad, wherein the seat is divided into three parts in a seat width direction. Specifically, the cushion body is divided into a central portion forming the central portion in the seat width direction and two side portions forming the side portions in the seat width direction.

The central portion and the two side portions are each covered with seat covers that enclose the seat pads. Each end of the seat cover is attached to a resin base substrate located on the backside of the seat pads. Furthermore, the seat cover is secured by being hooked onto clips that are mounted to the substrate through through-holes formed in the seat pad. Therefore, the central and side portions are configured such that each seat pad is sandwiched between the seat cover and the substrate.

In the configuration of the prior art, when a seat ventilator is provided in the seat, there is a risk that operating noise of the ventilator may readily be transmitted to the seater through through-holes formed in the seat pad. Accordingly, there is a need to provide a cushion body with a sound-dampening module that can suppress sound leakage through the through-holes of the seat pad.

### SUMMARY

In order to solve the above problem, the present disclosure has the following configuration.

The present disclosure relates to a cushion body that elastically supports a seater divided into three elements: a central portion forming a central part in a seat width direction, and two side portions forming respective side parts in the seat width direction. At least one of the divided elements comprises a seat pad, a base substrate provided on a back surface of the seat pad, and a seat cover that covers the seat pad from a front side and has a terminal portion fixed to the base substrate. The seat pad has a through-hole formed therein in a pad thickness direction. A soundproofing member provided to fill a gap between the seat pad and the base substrate so as to surround the through-hole.

### BRIEF DESCRIPTION OF DRAWINGS

FIG. 1 is a perspective view showing a schematic configuration of a cushion body according to a first embodiment.

FIG. 2 is an exploded perspective view of the cushion body removed from a back frame.

FIG. 3 is an exploded perspective view of a central portion.

FIG. 4 is an enlarged view of part IV of FIG. 3.

FIG. 5 is an exploded perspective view of FIG. 4 with a clip removed from a main substrate.

FIG. 6 is a perspective view of the upper half of a main pad as viewed from the back side of the pad.

FIG. 7 is a cross-sectional view of the central portion taken along line VII-VII of FIG. 6.

FIG. 8 is a front view showing the relationship between a mounting portion of the clip and a soundproofing member.

FIG. 9 is a cross-sectional view of the central portion taken along line IX-IX of FIG. 8.

FIG. 10 is a cross-sectional view of the central portion taken along line X-X of FIG. 8.

### DETAILED DESCRIPTION

Hereinafter, embodiments of the present disclosure will be described with reference to the drawings.

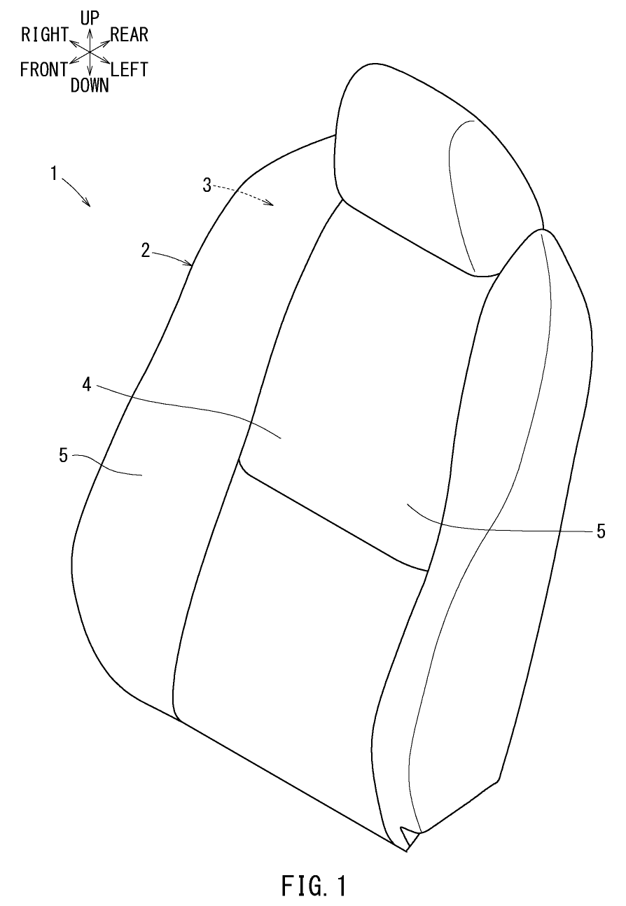

First, the configuration of a cushion body 2 according to a first embodiment of the present disclosure will be described with reference to FIGS. 1 to 10. In the following description, when directions such as front, rear, up, down, right, and left are indicated, these refer to the respective directions shown in each figure.

Furthermore, when directions are indicated with "seat" attached to each direction such as "seat width direction," they refer to directions based on a seat back 1 described later. In addition, in the following description, when a specific reference drawing is not shown or when there is no reference numeral corresponding to the reference drawing, any one of FIGS. 1 to 10 shall be referred to as appropriate.

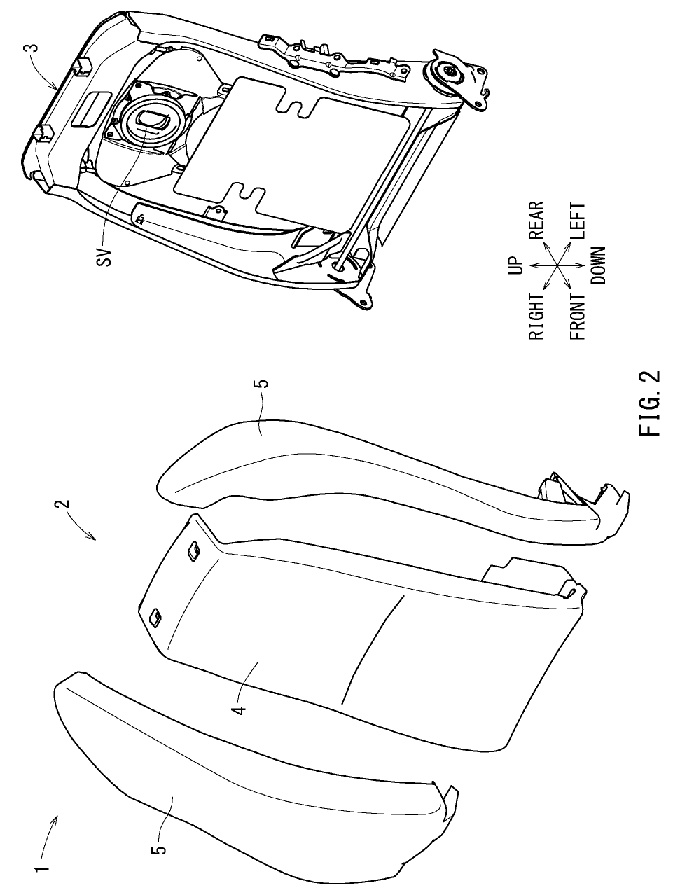

As shown in FIG. 1, the cushion body 2 is applied to the seat back 1 that forms a backrest portion of an automotive seat. The seat back 1 has the cushion body 2, which elastically supports the seater’s back, and a back frame 3 that supports the cushion body 2 from the rear (see FIG. 2).

The cushion body 2 is configured to be divided into three elements: a central portion 4 that forms a central portion in a seat width direction, and two side portions 5 that form both side portions in the seat width direction. The back frame 3 is made of a metal member assembled in a frame shape when viewed from the front.

Since the cushion body 2 is divided, parts can be replaced according to specifications for each divided portion. The central portion 4 and each side portion 5 are individually assembled to the back frame 3 after assembling the respective component parts into one unit for each divided portion.

Specifically, each side portion 5 is integrally fixed to the back frame 3 by fitting with clips (not shown) or fastening with bolts. The central portion 4 is set so as to be fitted between them from the front of the seat after each side portion 5 is assembled to the back frame 3. For example, the side portions 5 may be fixed to the back frame 3 with clips or bolts, and the central portion 4 is then fitted between them from the front. The central portion 4 is fixed such that its upper and lower portions are hooked to the upper and lower portions of the back frame 3.

The back frame 3 has a seat ventilator blower SV mounted in its upper area within the frame. This blower SV draws air in through the central portion 4 from the seat surface to suppress stuffiness during seating.

The central portion 4 and each side portion 5 share a common basic structure. Hereinafter, the configuration of each divided element of the cushion body 2 will be described in detail using the central portion 4 as an example.

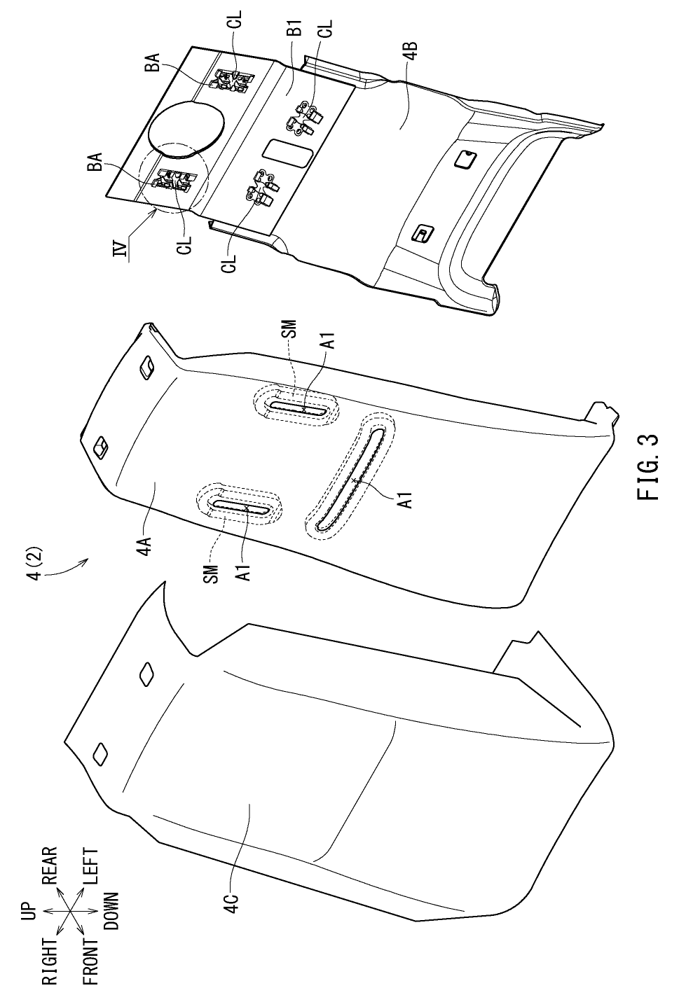

As shown in FIG. 3, the central portion 4 serves as an example of a divided element and includes a main pad 4A made of foamed urethane, and a main substrate 4B made of resin, which is disposed on the back surface of the main pad 4A. The central portion 4 also includes a main cover 4C made of fabric that covers the main pad 4A from the front surface side. The end of the main cover 4C is drawn into and secured to the back surface of the main substrate 4B.

The central portion 4 is assembled into a single module by integrating the main cover 4C is integrated and the main substrate 4B to wrap the main pad 4A between them . The main pad 4A, main substrate 4B, and main cover 4C are equivalent to the "seat pad," “base substrate,” and “seat cover of the present disclosure, respectfully.

The central portion 4 is integrally fixed by the main substrate 4B, which is provided on its rear surface and fitted onto the upper part of the back frame 3 (shown in FIG. 2) from above the seat. Furthermore, the central portion 4 is also integrally fixed by the lower end of the main cover 4C, which is pulled in from below into the lower part of the back frame 3 and hooked onto the underside of the seat.

As shown in FIG. 3, resin clips CL are attached to various locations on the main substrate 4B. These clips pull portions of the main cover 4C through a through-hole A1 formed in the main pad 4A and secure them in place. Each clip CL is snap-fitted into a corresponding mounting part BA formed in the main substrate 4B by being pressed into it.

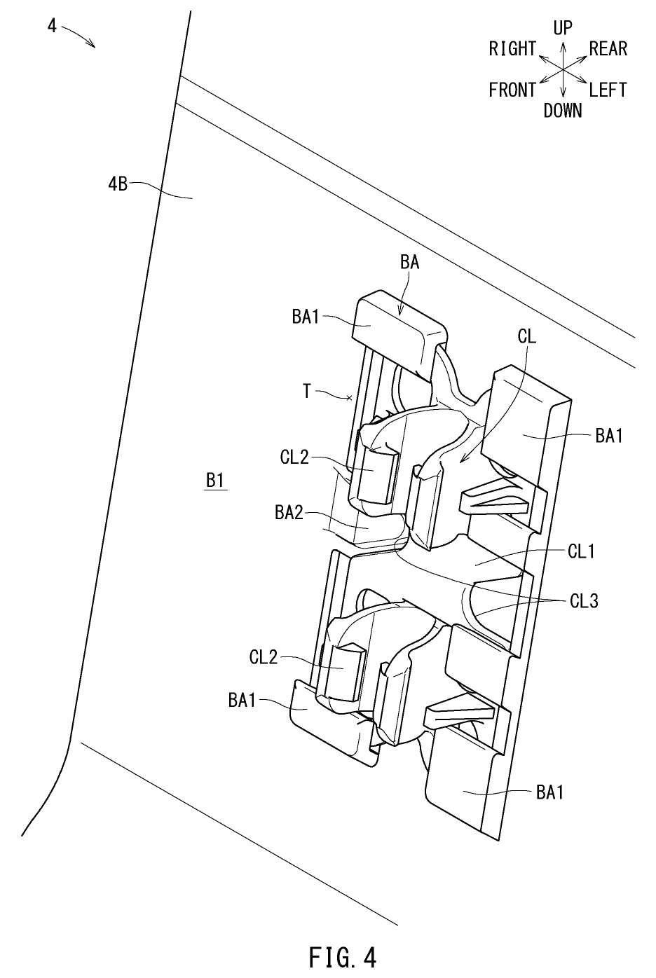

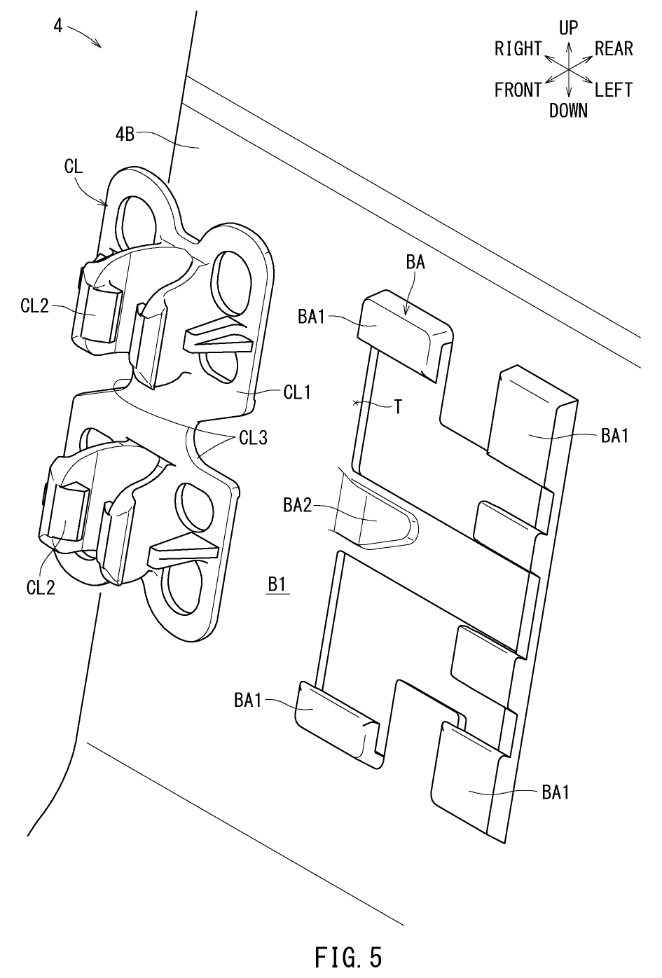

Next, the mounting structure of each clip CL to the main substrate 4B is described using the clip CL shown in FIGS. 4 and 5 as an example. The clip CL is secured to the mounting portion BA on a substrate surface B1 of the main substrate 4B, by insertion from the right side in the seat width direction. Thereby, the clip CL is fixed in a state of being pressed between the mounting portion BA and the substrate surface B1.

As shown in FIG. 5, the clip CL integrally comprises a flat plate-shaped clip base CL1, which serves as a base during mounting, and a hooking portion CL2 that protrudes forward from the clip base CL1 toward the front of the seat. The clip base CL1 is formed in a flat plate shape that is vertically elongated in front view.

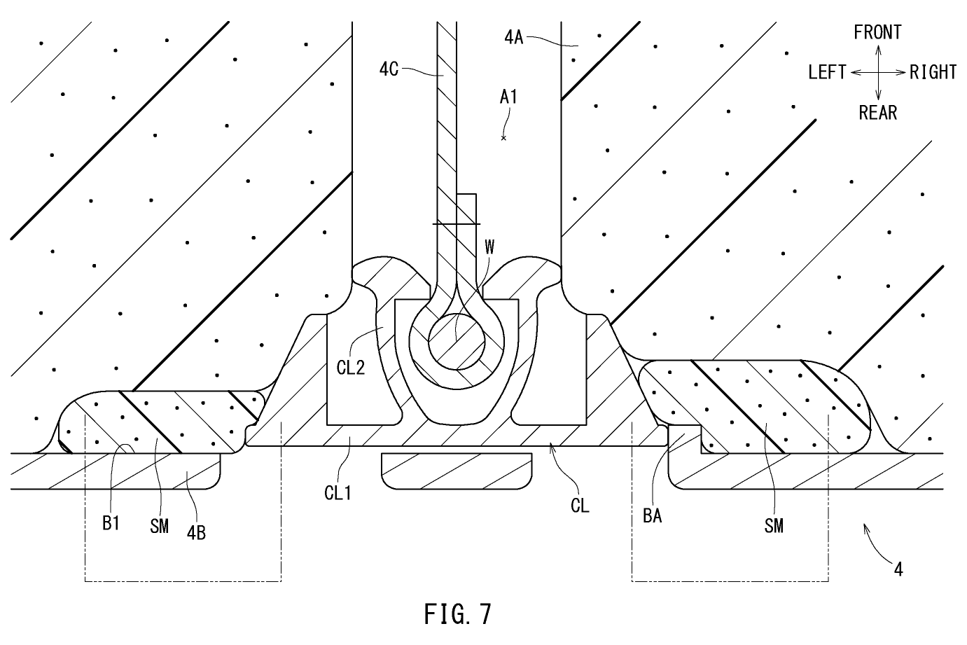

The hooking portion CL2 has a U-shape in a plan view and protrudes forward from two positions, an upper middle portion and a lower middle portion of the clip base CL1, toward the front of the seat. The tip of a hooking wire W (see FIG. 7), which is pulled in from the main cover 4C, is inserted into the U-shaped interior of the hooking portion CL2 from the front of the seat, thereby being snap-fitted in place.

The mounting portion BA includes a clamping portion BA1 that presses the four corners of the clip base CL1 between the clamping portion BA1 and the substrate surface B1. The clamping portion BA1 protrudes from the substrate surface B1 in a hook-shaped configuration and presses the four corners of the clip base CL1 from the front side of the seat. An opening T is formed between the clamping portion BA1 and the substrate surface B1, through which the clip base CL1 can be inserted by sliding it parallel to the substrate surface B1 from the right side in the seat width direction.

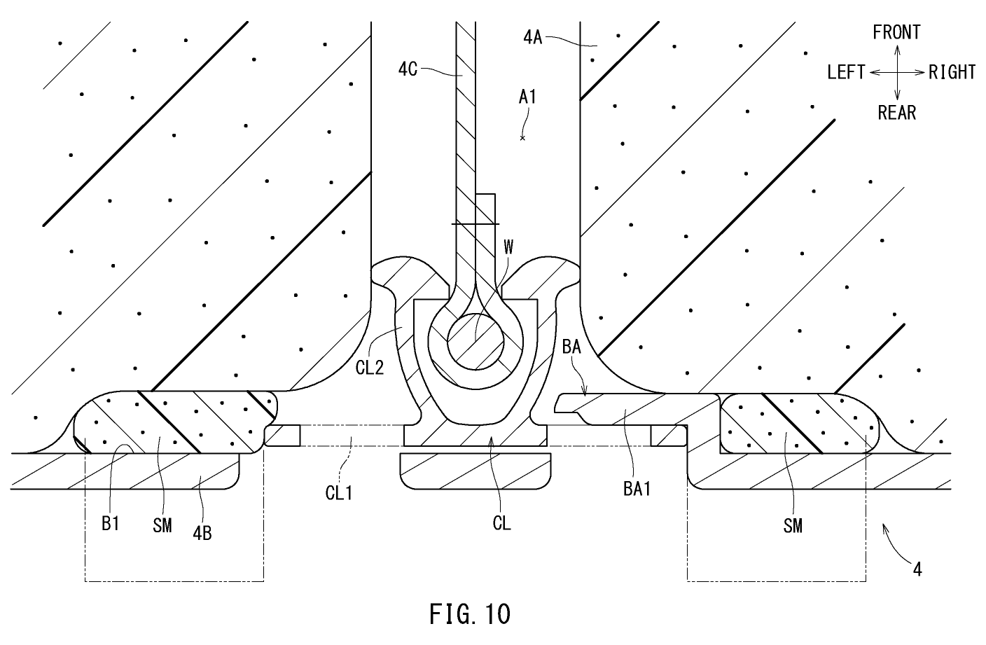

The clamping portion BA1 engages the clip base CL1 by contacting two of its corners at the insertion destination when the clip base CL1 is inserted to a position where all four corners are pressed along the substrate surface B1 (see FIGS. 4 and 10). The mounting portion BA includes a raised portion BA2 that causes the clip base CL1 to be inserted while being bent in an arc between the clip base CL1 and the clamping portion BA1 during insertion of the clip base CL1 described above.

The raised portion BA2 is formed to extend from the substrate surface B1 of the main substrate 4B. Specifically, it protrudes from the substrate surface B1 at a central portion between the two corners on the entrance side of the clamping portion BA1, where the clip base CL1 is inserted.

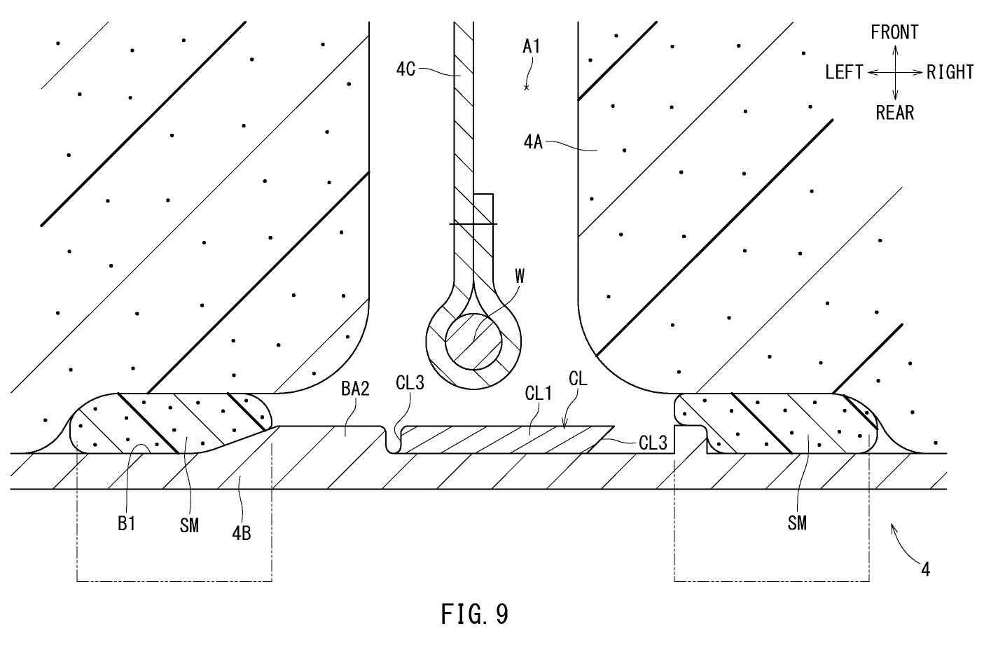

The raised portion BA2 is formed to extend at an incline from the substrate surface B1 of the main substrate 4B, allowing the clip base CL1 to ride up from the substrate surface B1 during insertion. Furthermore, the raised portion BA2 is positioned to restore the curvature of the clip base CL1 when it reaches the position where it is clamped at all four corners by the clamping portion BA1 (see FIGS. 5 and 9).

As shown in FIG. 5, the clip base CL1 has a shape with constrictions CL3 on both sides of its longitudinal center. Consequently, when the clip base CL1 is inserted from the right side in the seat width direction into the opening T between the clamping portion BA1 and the substrate surface B1, its upper and lower ends first enter between the two front corners of the clamping portion BA1 and the substrate surface B1. The constrictions CL3 allow the clip base CL1 to avoid interference with the raised portion BA2 during insertion.

Subsequently, as insertion progresses, the clip base CL1 rides over the raised portion BA2. Consequently, the clip base CL1 is inserted between the clamping portion BA1 and the substrate surface B1 while arching like a bow. This occurs due to the clamping of both ends by the two front corners of the clamping portion BA1 and the riding over of the raised portion BA2 at the center portion.

At this time, the hooking portion CL2, which extends from the clip base CL1, passes between the two right-side corners of the clamping portion BA1 to avoid interference. As shown in FIG. 4, the clip base CL1 is fully inserted when its four corners are clamped by the clamping portion BA1, which allows it to descend from the raised portion BA2 and restore its curvature. The raised portion BA2 then acts as a stopper to prevent the clip base CL1 from slipping outward in the seat width direction. This configuration leaves the clip seat CL1 securely clamped between the mounting portion BA and the substrate surface B1 (see FIG. 10).

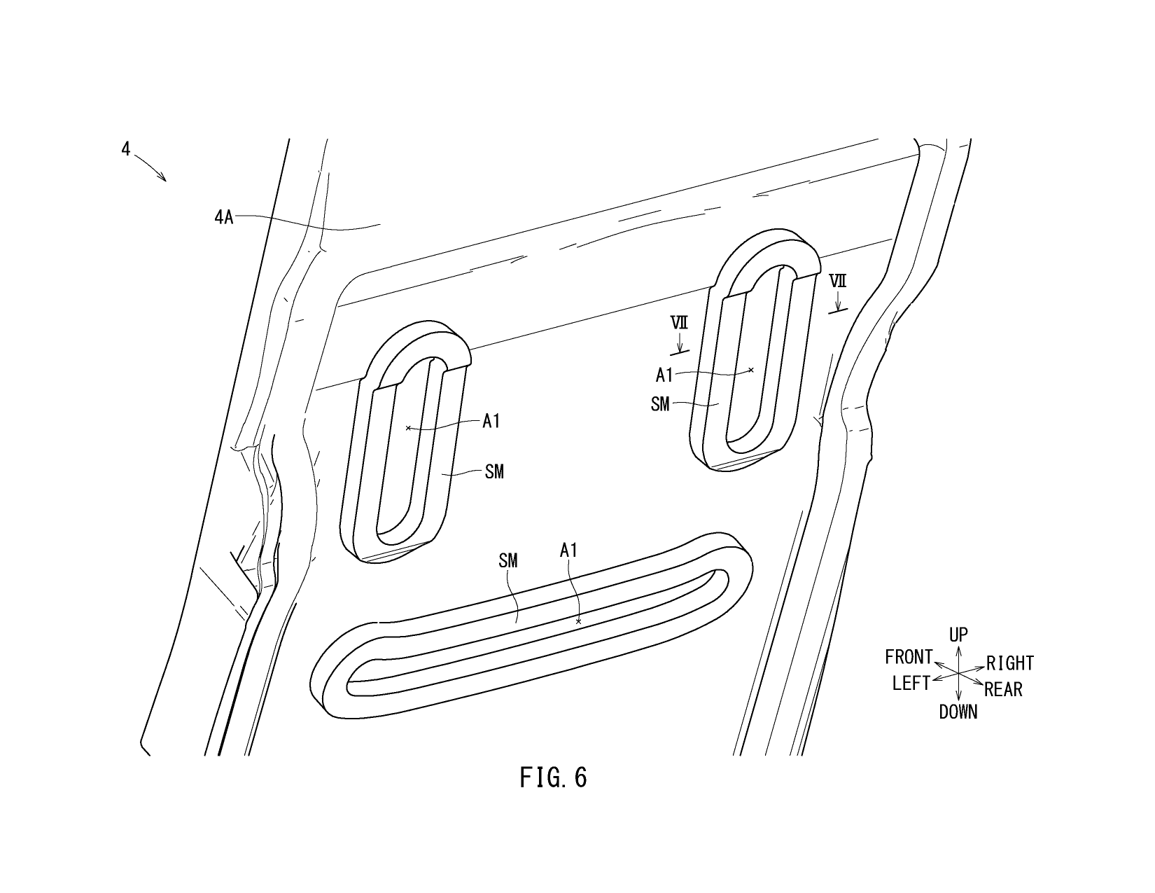

As shown in FIGS. 6 and 7, the main cover 4C is inserted into the rear side of the seat through the corresponding through-holes A1 formed in the main pad 4A. If a gap exists between the main pad 4A and the main substrate 4B, the operating noise of the blower SV (described in FIG. 2) may be transmitted to the occupant through the through-holes A1.

In order to suppress the transmission of such noise, sponge-based soundproofing members (SM) are disposed on the rear surface of the main pad 4A so as to individually surround each through-hole A1. Each soundproofing member SM is affixed to the rear surface of the main pad 4A by means of double-sided tape. Alternatively, each soundproofing member SM may be bonded to the rear surface of the main pad 4A using an adhesive.

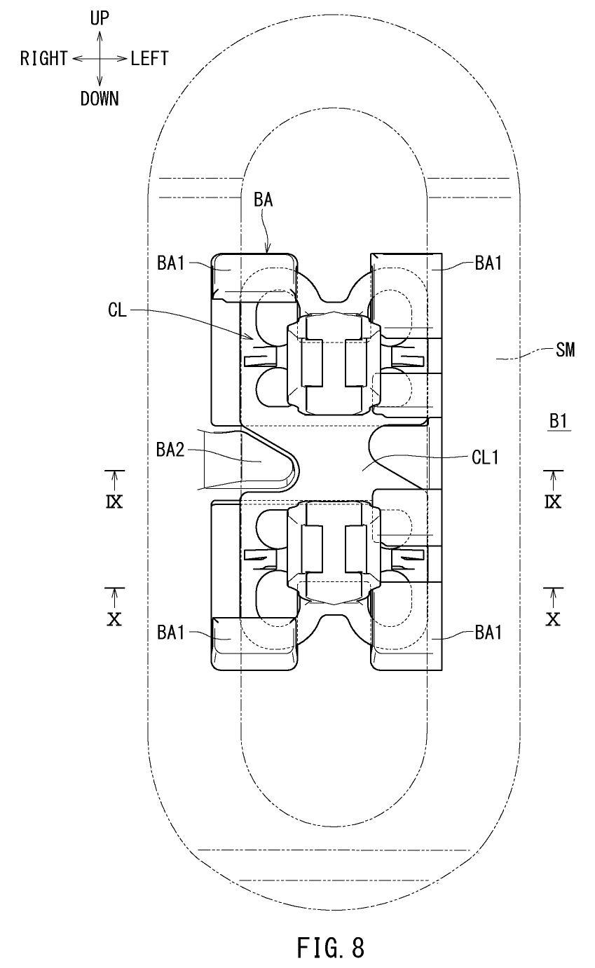

As shown in FIG. 7, when the central portion 4 is assembled into a single module, each soundproofing member SM is pressed against the front surface of the main substrate 4B. Specifically, as shown in FIG. 8, since each soundproofing member SM is disposed to surround a respective through-hole A1, it is pressed against the clamping portion BA1 and the area surrounding the clamping portion, and is laid over the clamping portion BA1 located at each of the four corners of the main substrate 4B.

Accordingly, each soundproofing member SM is compressed into a shape conforming to the uneven profile defined by the protrusion extending from the substrate surface B1 of the clamping portion BA1 and the recess located between the four corners of the clamping portion BA1. Therefore, as shown in FIG. 7, the gap between the main pad 4A and the main substrate 4B is effectively filled by each soundproofing member SM.

Each soundproofing member SM is configured to be attached to the rear surface of the main pad 4A, thereby facilitating accurate positioning so as to surround each through-hole A1. Furthermore, by employing a sponge material having a porous structure as the soundproofing member SM, sound leakage can be effectively suppressed. In addition, each soundproofing member SM can be appropriately compressed to conform to the shape of the gap between the main pad 4A and the main substrate 4B, thereby enabling effective suppression of sound leakage irrespective of the shape of the gap.

To summarize the above, the cushion body 2 according to the present embodiment has the following configuration. The reference numerals shown in parentheses below correspond to the respective components shown in the above embodiment.

A cushion body (2) that elastically supports a seater, wherein the cushion body (2) is divided into three elements: a central portion (4) forming a central part in a seat width direction, and two side portions (5) forming respective side parts in the seat width direction. At least one of the divided elements comprises a seat pad (4A), a base substrate(4B) provided on a back surface of the seat pad (4A), and a seat cover (4C) that covers the seat pad (4A) from a front side and has a terminal portion fixed to the base substrate (4B).

The seat pad (4A) has a through-hole (A1) formed therein in a pad thickness direction. A soundproofing member (SM) provided to fill a gap between the seat pad (4A) and the base substrate (4B) so as to surround the through-hole (A1). Therefore, even when a seat ventilator is provided on a rear side of the cushion body (2), the soundproofing member (SM) suppresses transmission of operating noise of the blower (SV) to the seater through the through-hole (A1) of the seat pad (4A). Consequently, sound leakage through the through-hole (A1) of the seat pad (4A) can be appropriately suppressed.

In addition, the soundproofing member (SM) is attached to the back surface of the seat pad (4A). Therefore, the soundproofing member (SM) can be easily positioned so as to surround the through-hole (A1) of the seat pad (4A). Positional deviation of the soundproofing member (SM) relative to the through-hole (A1) can also be appropriately suppressed.

In addition, the soundproofing member (SM) is typically formed of a sponge having a porous structure, which enables effective suppression of sound leakage. Further, the soundproofing member (SM) can be appropriately compressed in conformity with the shape of the gap, thereby enabling effective suppression of sound leakage irrespective of the shape of the gap.

The base substrate (4B) comprises a mounting portion (BA) having a convex/concave shape formed on the base substrate (4B) at a location facing the soundproofing member (SM), and a clip (CL) attached to the mounting portion (BA) for hanging the seat cover (4C) that passes through the through-hole (A1). The soundproofing member (SM) is compressed to conform to the concavo-convex shape of the mounting portion (BA). This integrated design achieves both the mounting of the clip (CL) and effective suppression of sound leakage.

The present disclosure has been described above with reference to one embodiment. However, the present disclosure is not limited to the above embodiment and may be implemented in various other forms.

The cushion body of the present disclosure can also be applied to seats of vehicles other than automobiles, such as railways, aircraft, ships. The cushion body can also be applied to non-vehicle seats installed in various facilities such as sports facilities, theaters, concert halls, event venues, in addition to vehicles. The cushion body can also be applied to seat structures other than seat cushions, such as headrests, ottomans, armrests.

Among the divided elements of the cushion body, the divided element in which the through-hole penetrates the seat pad in the pad thickness direction and the soundproofing member fills a gap between the seat pad and the base substrate while surrounding the through-hole may be the side portion. The through-hole is not specifically limited in its use; it may be for passing a seat cover to the seat rear side, for passing a wire harness, or for other purposes.

The soundproofing member may be formed of rubber instead of a sponge. The soundproofing member only needs to fill the gap between the seat pad and the base substrate surrounding the through-hole and does not necessarily have to possess elasticity sufficient to be compressed in conformity with the shape of the gap. The soundproofing member may be mounted to the base substrate instead of, or in addition to, the pad back surface. The soundproofing member may also be pressed against a general surface of the base substrate, i.e., a portion other than the mounting portion on which the clip is mounted.

The various examples described above in detail with reference to the attached drawings are intended to be representative of the present disclosure and are thus non-limiting embodiments. The detailed description is intended to teach a person of skill in the art to make, use and/or practice various aspects of the present teachings, and thus does not limit the scope of the disclosure in any manner. Furthermore, each of the additional features and teachings disclosed above may be applied and/or used separately or with other features and teachings in any combination thereof, to provide an improved cushion body, and/or methods of making and using the same.

We claim:

1. A cushion body that elastically supports a seater and is divided into three elements, comprising:
a central portion forming a central part in a seat width direction; and
two side portions forming respective side parts in the seat width direction,
wherein at least one of the three elements comprises a sound-dampening module,
the module comprising:
a seat pad;
a base substrate provided on a back surface of the seat pad;
a seat cover that covers the seat pad from a front side and has a terminal portion secured to the base substrate;
a through-hole formed in the seat pad in a pad thickness direction, wherein the through-hole configured to allow a portion of the seat cover to pass to the rear side of the seat; and
a soundproofing member, which is formed of a porous material and provided to fill a gap between the seat pad and the base substrate so as to surround the through-hole.

2. The cushion body according to claim 1, wherein the soundproofing member is attached to the back surface of the seat pad.

3. The cushion body according to claim 1, wherein the soundproofing member is a sponge.

4. The cushion body according to claim 1, wherein the base substrate comprises a mounting portion that secures a clip, and the mounting portion has a convex/concave shape formed on the base substrate at a location facing the soundproofing member.

5. The cushion body according to claim 4, wherein the clip is secured to the mounting
portion for hanging the seat cover that passes through the through-hole.

6. The cushion body according to claim 1, wherein the soundproofing member is
compressed so as to conform to the concavo-convex shape of the mounting portion.

7. The cushion body according to claim 1, wherein the soundproofing member is
affixed to the back surface of the seat pad by a double-sided tape.

8. The cushion body according to claim 1, wherein the soundproofing member is
bonded to the back surface of the seat pad using an adhesive.

9. The cushion body according to claim 1, wherein the soundproofing member is
formed of rubber.

10. The cushion body according to claim 1, wherein the through-hole is configured for
passing a wire harness.
